(19) United States
(12) Patent Application Publication
(10) Pub. No.: US 2020/0056689 A1
(43) Pub. Date: Feb. 20, 2020

(54) Linear Drive Actuator

(71) Applicant: Creative Motion Control, Inc., Woodinville, WA (US)

(72) Inventor: Shawn Lawlor, Woodinville, WA (US)

(21) Appl. No.: 16/499,670

(22) PCT Filed: Apr. 2, 2018
(86) PCT No.: PCT/US18/25760

§ 371 Date: Sep. 30, 2019

Related U.S. Application Data
(60) Provisional application No. 62/480,183, filed on Mar. 31, 2017.

(51) Int. Cl. F16H 25/22; F16N 11/08

(52) U.S. Cl. CPC F16H 25/2247; F16H 2025/2087; F16N 11/08

(57) ABSTRACT

A linear drive actuator that includes a linear drive mechanism that includes a hollow, threaded roller screw shaft with a thrust bearing formed on one end and a roller screw nut mounted on the opposite end moves axially over the shaft when the shaft is rotated. Attached to the roller screw nut is a hollow extension tube that both extends into a main housing. The distal end of the extension tube extends through the end of the main housing and includes an end cap or a connector. The proximal end of the drive shaft connects to a drive axle on a multiple gear assembly. The multiple gear assembly is coupled to a dual motor assembly. Located adjacent to the dual motor assembly is a volume compensation housing that contains a moving piston that divides the housing lubricant holding chamber filled with a lubricating fluid and an air chamber that communicates with outside air. During operation, the lubricating flows into the motor assembly, the gear assembly, into the nut body and to the extension tube. The amount and direction of flow of lubricating fluid is controlled by the axial movement of the roller screw nut and extension tube to continuously lubricate and cool the actuator.

This utility patent application is based on and claims the filing date benefit of U.S. provisional patent application (Application 62/480,183) filed on Mar. 31, 2017.

### TECHNICAL FIELD

This invention relates to linear drive actuators, and more particularly to portable, compact linear drive actuators.

### BACKGROUND ART

Linear driver actuators used with portable hand tools commonly include a hydraulic cylinder coupled to an internal or external gas or electricity powered hydraulic pump. The hydraulic cylinder and pump require periodic inspections and maintenance. Also, the hydraulic cylinder and pump limit the size of the actuator.

Linear drive actuators are desirable because they are compact and lightweight. Unfortunately, they use roller screws that need lubrication and produce heat.

### DISCLOSURE OF THE INVENTION

It is an object of the present invention to provide a durable, lightweight, compact and versatile linear drive actuator that uses a roller screw as the mechanical linear drive mechanism.

It is another object of the present invention to provide a linear drive actuator that uses a roller screw with greater lubrication and heat dissipating features.

Disclosed herein is a linear drive actuator that includes an improved linear drive mechanism that uses a solid or hollow, threaded roller screw shaft with a low clearance, high capacity roller bearing, herein after called a thrust bearing, integrally formed or shaped on its proximal end. An inner race with a plurality of non-helical grooves is formed on the proximal end of the shaft. Disposed longitudinally and axially around the inner race is a plurality of parallel rollers that include a plurality of teeth. Disposed around the rollers is a cylindrical outer race with a set of non-helical grooves configured to mesh with the teeth on the rollers.

Mounted over the distal end of the roller screw shaft is a roller screw nut. The roller screw nut includes an outer race, a plurality of grooved rollers axially aligned inside the outer race, and an inner race. When the roller screw shaft is rotated, the roller screw nut moves axially over the roller screw shaft. A hollow extension tube longitudinally aligned with the roller screw shaft and configured to axially move with the roller screw nut.

Surrounding and covering the roller screw housing and the extension tube is a closed main housing configured to be filled with lubricating fluid. The extension tube is sufficient in length, so its distal end extends from the distal end of the main housing and connects to an end termination or a tool implement.

The proximal end of the roller screw shaft connects to a drive axle from a gearbox assembly located in a gearbox housing. The gearbox housing is attached to a motor housing containing at least one primary motor. Located adjacent to the motor housing is a volume compensator housing with an internal filling cavity. A sealing piston divides the filling cavity into a lubricating holding chamber filled with a lubricant fluid and an air chamber that communicates with atmospheric air.

The gearbox housing and motor housing include fluid passages that allow lubricating fluid to flow back and forth through the main housing and into and around the roller screw shaft and the elongated tube. During operation, lubricating fluid flows through the motor housing, through the gearbox housing, through the roller screw shaft, through the extension tube and into the main housing. During operation, the axial movement of the nut body and the extension tube changes the volume of the main housing which causes lubricating fluid to flow back and forth between the lubricating holding chamber and the main housing. The lubricating fluid further acts as a heat transfer media which conducts heat away from the gearbox, the motors, the thrust bearing and roller nut to the main housing where the heat can⁻be readily conducted to the external environment, cooling the system.

### BRIEF DESCRIPTION OF THE DRAWINGS

FIG. 1 is a perspective view of an improved linear drive actuator shown herein.

FIG. 2 is an exploded, perspective view of the improved linear drive actuator.

FIG. 3 is a sectional, side elevational view of the improved liner drive actuator.

FIG. 4 is a sectional perspective view of the volume compensating housing.

FIG. 5 is a sectional perspective view of motor assembly.

FIG. 6 is a sectional, perspective view of the gearbox assembly.

FIG. 7 is a front perspective view of the multiple gear system used in the gearbox assembly.

FIG. 8 is a rear perspective view of the multiple gear system used in the gearbox assembly.

FIG. 9 is a sectional perspective view of the multiple gear system.

FIG. 10 is an end elevational view of the gearbox housing.

FIG. 11 is a sectional perspective view of the roller screw shaft attached to the gearbox housing.

FIG. 12 is an end elevational view of the roller screw shaft.

FIG. 13 is a sectional side elevational view of the distal end of the roller screw shaft with the rotating roller nut attached to the roller screw shaft that axially extends or retracts the elongated tube.

FIG. 14 is a partial, sectional side elevational view of the roller nut mounted on the drive screw.

FIG. 15 is sectional side elevational view of the main housing.

### BEST MODE FOR CARRYING OUT THE INVENTION

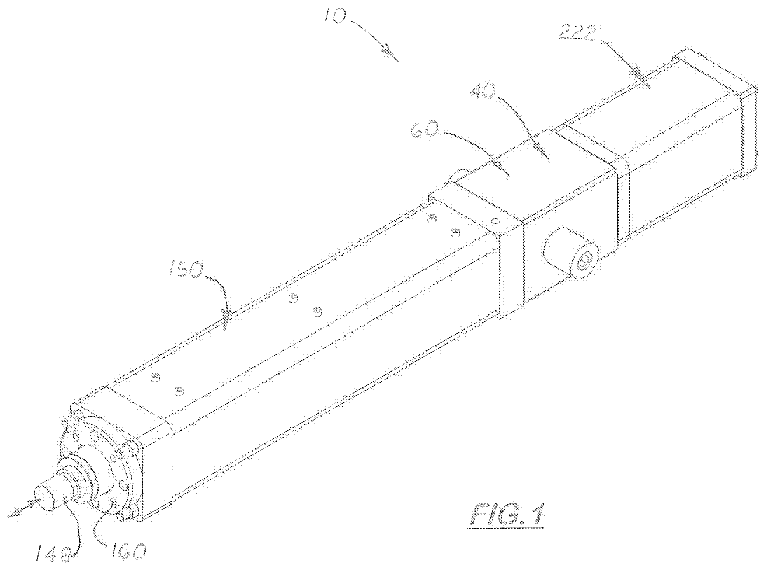

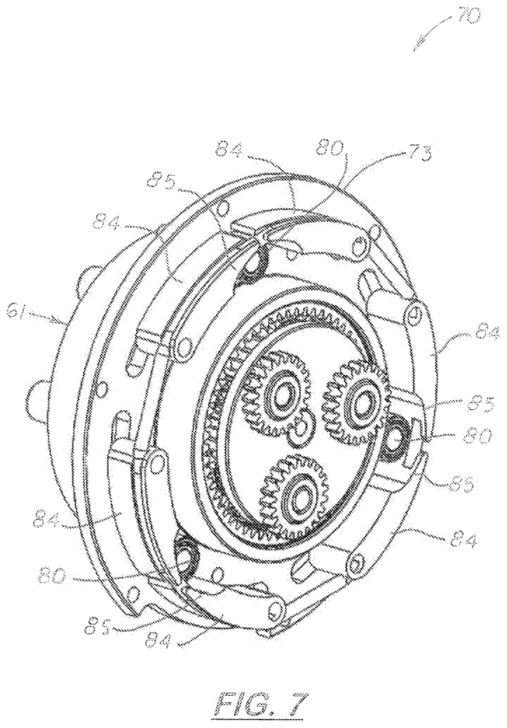

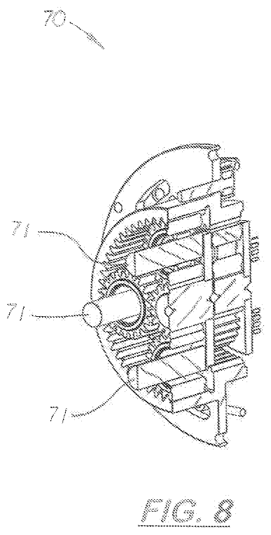

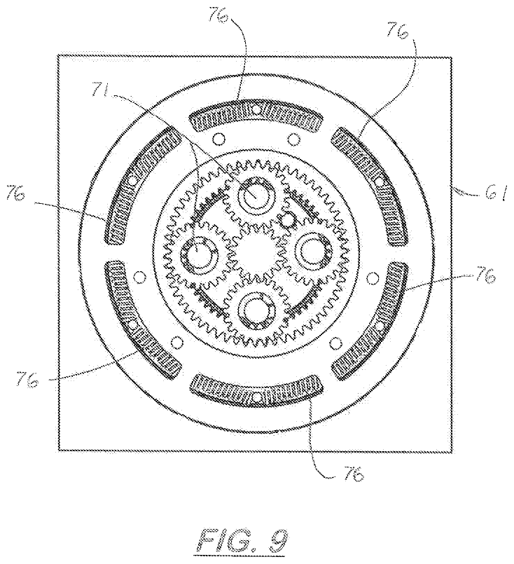

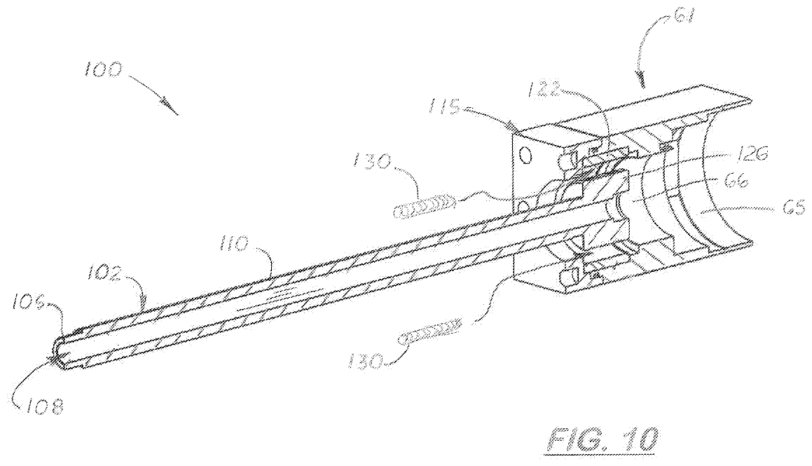

Disclosed herein in FIGS. 1-15 is a linear drive actuator 10 with a motor assembly 40, a multiple gear and torque sensing assembly 60, an improved linear drive mechanism 100, and an internal closed lubricating and cooling system 220.

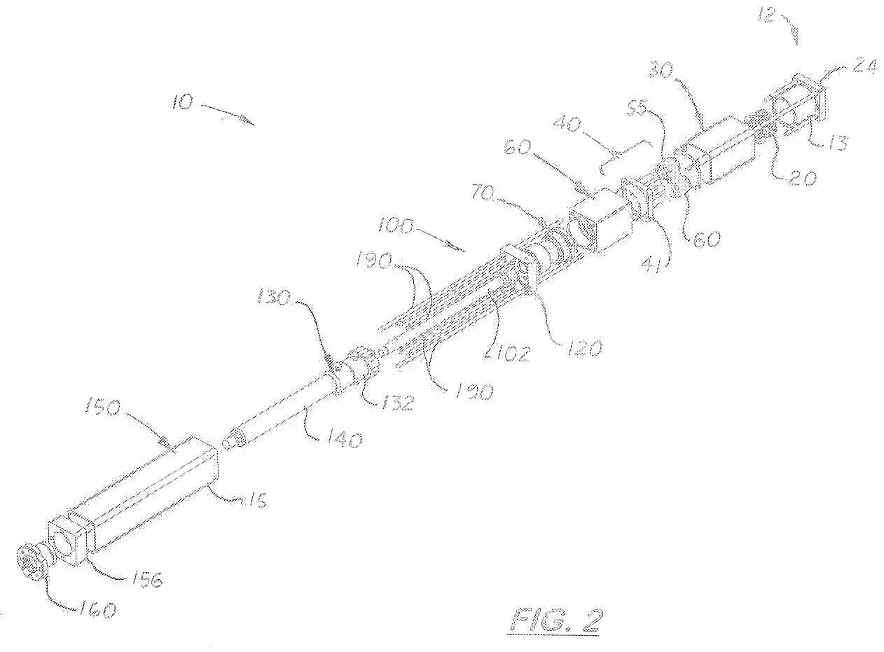

The improved linear drive mechanism 100, (shown in FIGS. 2, 11, and 13) uses a hollow, threaded roller screw shaft 102 with a low clearance, high capacity roller bearing, herein after called a thrust bearing 120. The thrust bearing 120 includes an inner race 126 with a plurality of non-helical grooves 128 formed on the proximal end 104 of the screw shaft 102. Disposed longitudinally and axially around the inner race 126 is a plurality of parallel rollers 130 that include a plurality of teeth 132. Disposed around the rollers 130 is a cylindrical outer race 122 with a set of non-helical grooves 124 configured to mesh with the teeth 132 on the rollers 130.

Mounted on the screw shaft 102 is a thrust bearing retainer plate 112 aligned over the distal opening formed on a gearbox housing 61 that houses a multiple gear and torque sensing system 60.

Mounted over the section distal end of the screw shaft 102 is a roller screw nut 136. The roller screw nut 136 includes an outer race, a plurality of grooved rollers axially aligned inside the outer race 138, and an inner race 140. When the roller screw shaft 102 is rotated, the roller screw nut 136 moves axially over the screw shaft 102. A hollow extension tube 145 is longitudinally aligned with the screw shaft 102 and configured to axially move with the roller screw nut 136. Attached to the distal end of the roller nut 137 is a hollow, elongated extension tube 145

Surrounding and covering the roller screw housing 137 and the extension tube 145 is a closed main housing 150. The extension tube 145 is sufficient in length so its distal end extends from the distal end opening on a main housing 150 and connects to a terminating end element of a tool implement (not shown).

### Motor Assembly

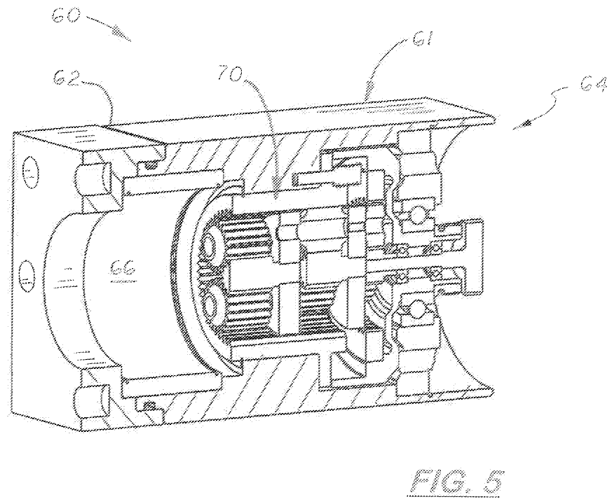

As shown more clearly in FIG. 5, the motor assembly 40 is similar to the motor assembly disclosed in U.S. patent application Ser. No. 15/525,824, and now incorporated therein. The motor assembly 40 includes a motor bracket 41 with a cylindrical rear body 42 and a cylindrical front neck 46. Between the rear body 42 and the front neck 46 is a transverse support plate 45. Formed on the rear body 42 are two motor mounts 48, 49, that receive the primary motor 50 and secondary motor 55.

During assembly, the motors 50, 55 are axially aligned in the motor mounts 48, 49, respectively, so the drive shaft 52 on each motor 50 extends through the transverse plate 45. A pinion gear 54 is attached to each drive axle 52. Formed on the transverse plate 45 is at least one fluid hole 47 that allows the lubricating fluid 300 to flow back and forth through the transverse plate 45. In one embodiment, the drive shaft on the primary electric motor 50 is connected to pinion gear in the gearbox housing. Surrounding the pinion gear is a coaxially carrier ring with an appropriate number of equal size planet gears mounted thereon. The planet gears include teeth that mesh with exterior teeth on the pinion gear. Surrounding the carrier ring is a coaxially aligned outer ring gear with inner teeth that mesh with teeth on the planet gears. The outer ring gear is fixed relative to the pinion gears so the carrier ring and the pinion gears rotate inside the outer ring gear. The gear ratio of the roller screw shaft 20 to the primary electric motor 160 and the pinion gear is approximately 1:5 but can vary over a wide range depending on the final application of the liner drive actuator 10.

### Gearbox Assembly and Torque Sensing System

Positioned in front of the motor assembly bracket 41 is a multiple gearbox assembly and torque sensing system 60. The gearbox assembly 60 includes a gear box housing 61 with a distal end opening 62 and a proximal end opening 64. Formed inside the gear box 61 housing is a gear cavity 65 configured to receive the multiple gear system 68. Attached to the distal end opening 62 is a thrust bearing retainer plate 120.

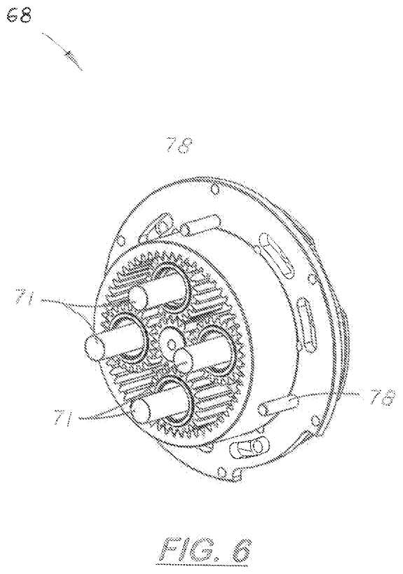

The multiple gear system 68, shown in FIGS. 6-10 includes a first stage ring gear 70. When first stage ring gear 70, is fixed and not allowed to rotate, the overall speed reduction of the gearbox assembly 60 is maximized and the output speed (rotation rate of drive pins 72) of the gearbox assembly 60 is minimized. When the internal brake holding ring gear 70 is released and secondary motor 55 is energized so the first stage ring gear 70 is rotated, then the effective speed reduction (gear ratio) of the first stage of the gearbox 60 is reduced thereby decreasing the overall speed reduction of the entire gearbox 60 and increasing its output speed.

The second and third stage ring gear sleeve and flange 73 is supported radially and axially by the gearbox housing 61 but may rotate within the gearbox housing 61. It is supported in the circumferential direction (rotationally) by a plurality of coil springs 76 which progressively compress as the output torque of the system increases. The deformation of these coil springs 76 results in the progressive rotation of the second and third stage ring gear sleeve and flange 74, the second stage ring gear 78 and the cylindrical extension elements 80. Cylindrical extension elements 80 are positioned to apply a normal force to profile incorporated into the inner surface of friction brake element 84. The rotation of these extension elements 80 in response to the output torque of the gearbox provides the control feedback for the system thus acting as a torque sensing system. In the current embodiment, the progressive rotation of control profile 91 relative to the stationary external gearbox housing 61 is used to open or close a control switch (not shown) for the secondary motor 55.

The internal surface of the cylindrical extension element 80 bears upon a profile or cam shape 85 on the interior surface of the friction brake element 84. The cylindrical extension element 80 rotates progressively along with all the other components in response to the deformation of the coil spring supports 76. Prior to the application of the ring gear brake, when the output force of the actuator 10 is low, the cam shape 85 is positioned so a control switch (not shown) is closed and the secondary motor 55 is activated which causes the ring gear 70 to rotate, reducing the gear ratio from the primary motor 50 to the output drive pins 71. The output speed of the gearbox 60 decreases as the actuator's internal drive torque and overall output force increases.

### Improved Linear Drive Mechanism

Located in front of the gear box housing 61 is an improved linear drive mechanism 100 that includes a hollow roller screw shaft 102 with a wide cylindrical inner race 126. Attached to the front or distal end of the gear box housing 61 is a end cap 115. Formed inside the end cap 115 is an inner cavity 66 that forms the outer race 122 to holds a separately inserted outer race 122. During assembly, the proximal end of the screw shaft 102 is inserted into the closed cavity. Disposed between the outer race 122 and the inner race 126 are a plurality of rollers 130. In combination, the screw shaft 102, outer race 122, the inner race 126 and rollers 130 form a thrust bearing similar too the low clearance high capacity roller bearing disclosed in U.S. patent application Ser. No. 15/523,620, filed on May 1, 2017, now incorporated by reference.

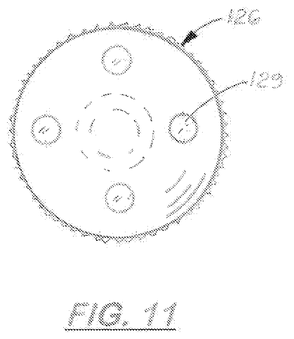

The screw shaft 102, shown more clearly in FIG. 11, includes a longitudinally aligned center bore 108 and a cylindrical shaped, wide inner race 126 integrally formed near the proximal end 104. Located inside the front cavity 66 on the gearbox housing 61 is a fixed outer race 122. Formed on the inside surface of the outer race 122 are non-helical grooves 124. Disposed between the inner race 126 and the outer race 106 are a plurality of parallel and longitudinally aligned rollers 130. Each roller 130 includes a plurality of teeth 132 configured to mesh with the non-helical grooves 128 formed on the inner race 126. Formed and extending the full length of the screw shaft 102 are helical threads 110.

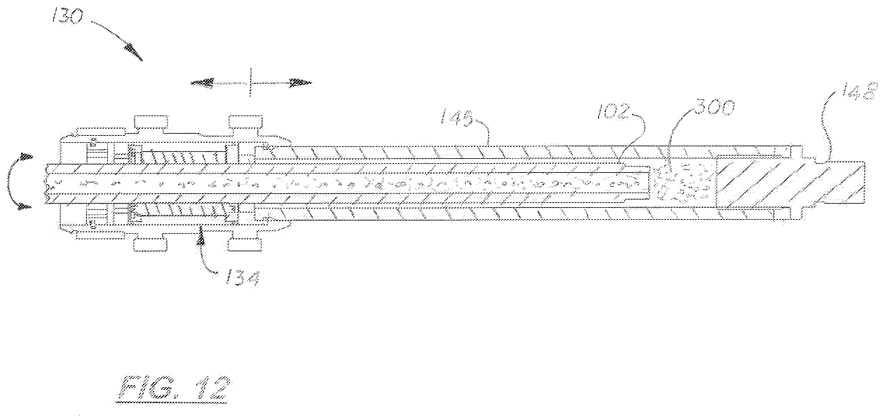

The inner race 126 is integrally formed on the proximal end of the screw shaft 102. As shown in FIG. 12, the proximal end surface of the inner race 126 includes four pegs holes 129 that receive the pegs 71 on the gearbox assembly 60. When the pegs 71 are rotated, the inner race 126 rotates inside the outer race 122 which causes the entire screw shaft 102 to rotate. As the screw shaft 102 rotates, the roller nut 134 discussed further below moves axially over the screw shaft 102.

### Roller Screw Nut

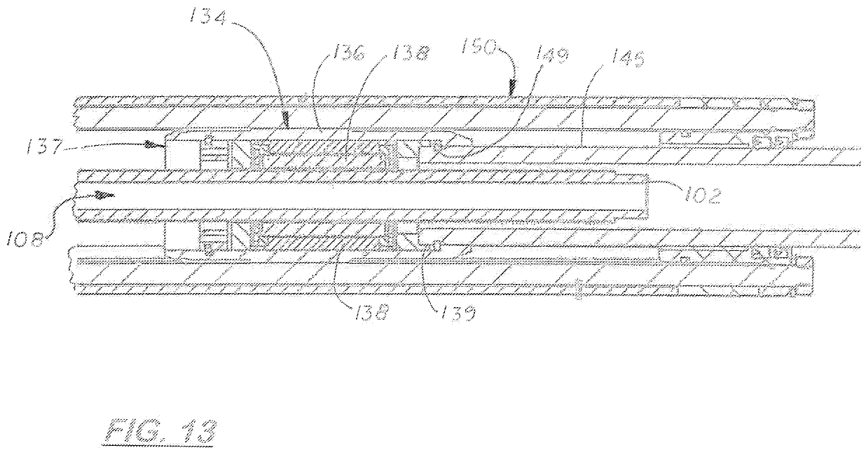

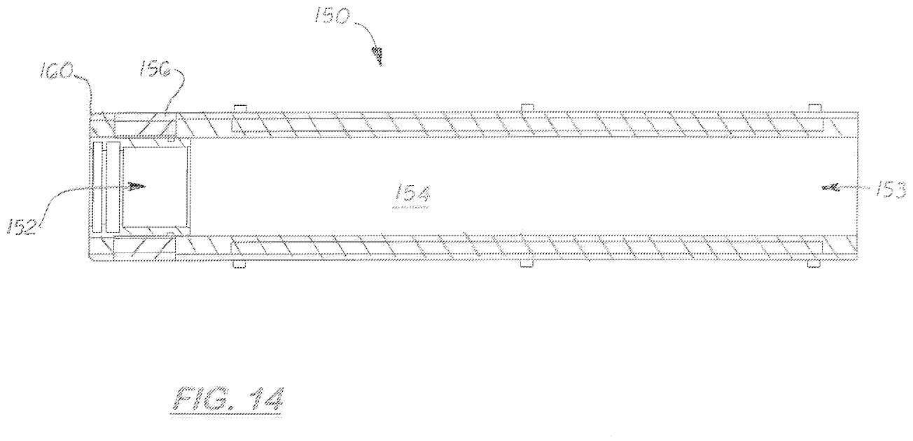

The roller screw nut 134 is similar to the geared planetary roller screw shown in U.S. Pat. No. 2,683,379 (Strandgren) which is now incorporated herein. The roller screw nut 134, shown in FIG. 14, includes an outer nut holder 136, that surrounds a roller nut body 137. Located inside the roller nut body 137 is a plurality of rollers 138. Located on each end of the screw nut 134 in an alignment spacer 139 and a pre-load ring. (See FIG. 13).

When the screw shaft 102 is rotated, the roller nut 134 moves longitudinally over the screw shaft 102. Formed on the distal end of the roller nut 134 is a recessed circular groove 139 that receive a tab 149 formed on the proximal end of the extension tube 145 to securely connect the nut body 137 to the extension tube 145.

### Extension Tube and Main Housing

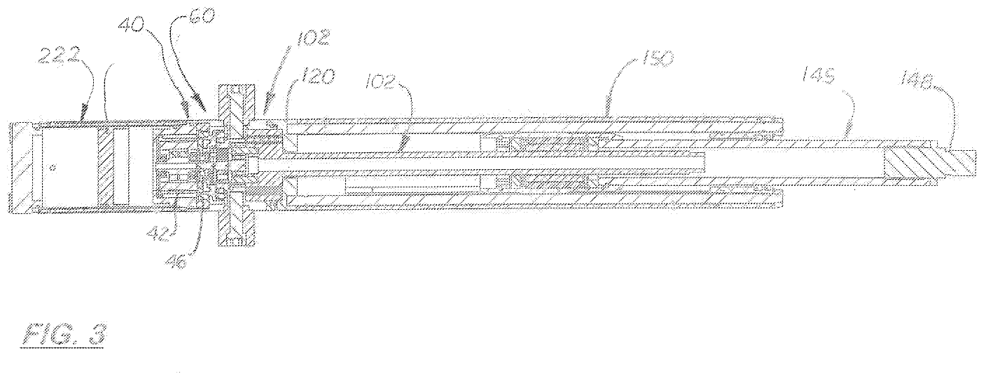

As mentioned above, and shown in FIGS. 3, 10, and 12 attached to the roller nut housing 132 is a hollow extension tube 145. The distal end of the extension tube 145 is closed with a clevis 148. Longitudinally aligned over the screw nut 134 and the extension tube 145 is an elongated main housing 150. Attached to the distal end of the main housing 150 is a sealing end cap 156. During assembly, the screw shaft 102 is inserted into the roller nut 134 and the roller nut 134 and the extension tube 145 are longitudinally aligned and inserted into the main housing 150. The distal end of the extension tube 145 includes a clevis 148 or other similar end connector that extends from the bore formed on the end cap 156 on the distal end of the main tube 150 and connects to a tool or application. When the screw shaft 102 is rotated, the roller nut 134 and the extension tube 145 move axially inside the main housing 150.

### Lubricating and Cooling Fluid Flow System

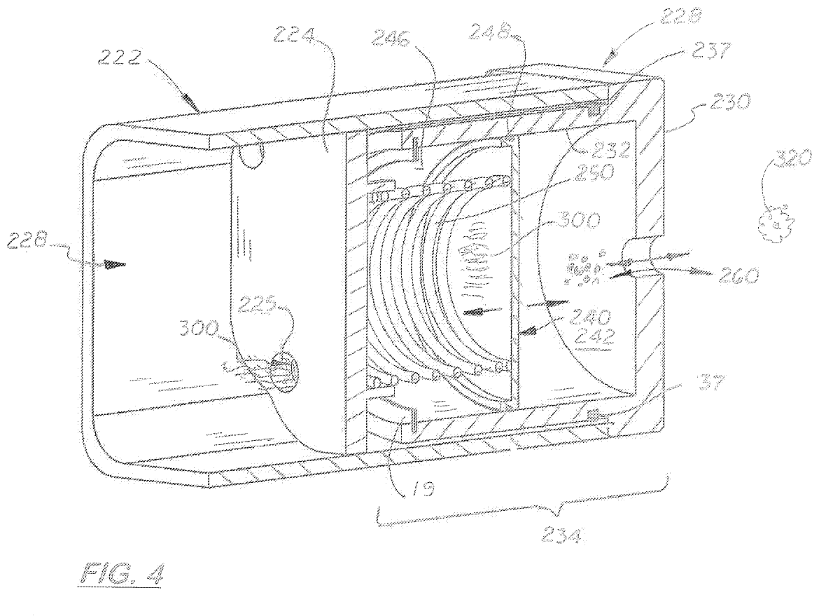

The linear drive actuator 10 includes a lubricating and cooling system 220 used to continuously lubricate and cool the actuator during operation. The system 220 includes volume compensation housing 222 located adjacent to the motor assembly 40 and opposite the multiple gearbox and torque sensing system 60. The volume compensation housing 222, shown in FIG. 4, includes an opened proximal end 32 and an opened distal end 34. Located inside the housing 222 is a transversely aligned intermediate wall 224.

Extending into the proximal end opening 226 is an end cap 228 that includes an end plate 230 and a cylindrical body 232 that extends perpendicularly from the inside surface of the end plate 230. The inside void area in the cylindrical body 232 forms a filling cavity 234. An o-ring 237 is mounted between the inside surface of the volume compensation housing 222 and the outside surface of the cylindrical body 232 to form a water tight seal.

Located inside the filling cavity 234 a transversely aligned piston 240 that divides the filling cavity 234 into a rear air chamber 242 and a front lubricant holding chamber 246. An air hole 244 is formed on the end plate 230 which connects the air chamber 242 to the atmosphere. The piston 240 is configured to slide inside the cylindrical body 232. An o-ring 248 is placed between the outer edge of the piston 240 and the inside surface of the cylindrical body 232 to create a watertight seal.

Between the intermediate wall and the piston 240 is a coil spring 250 configured to create a rearward biasing forcing on the piston 240.

Dispensing into the lubricating holding chamber 246 is a lubricating fluid 300, such as mineral oil. Formed on the intermediate wall is a fluid hole 260 that enables lubricating fluid 300 to flow into the lubricant holding chamber 246. Formed on the front plate 224 is a fluid hole 225

During operation, the piston 240 moves longitudinally inside the filling cavity 234 in response to differences in pressure between the atmosphere and the pressure exerted on the lubrication volume created by movement of the roller nut bearing housing and the extension tube 145 discussed further below.

### Operation

During assembly, lubricating fluid 300 is poured into the lubricating holding chamber 246 formed in the volume compensation housing 222. Lubricating fluid 300 then flows into the front cavity 228 of the volume compensation housing 222 around the primary and secondary motors 55, 60 through the motor bracket and into the gearbox cavity. The lubrication fluid 330 then flows around the thrust bearing 120, around the screw shaft 102 and into the roller screw bore 108. The lubrication fluid 300 then flows into the extension tube 145. The entire system is closed so that when the volume for the lubricating fluid 300 inside the extension tube 145 changes, lubricating fluid 300 flows back and forth between the filling cavity and the extension tube 145 according to pressure differences between the atmosphere and the extension tube 145. For example, when the extension tube 145 is extended, the volume for the lubricating fluid 300 inside the extension tube 145 is increased which draws lubricating fluid 300 from the lubrication fluid chamber 246 into the motor bracket, through the gearbox housing 61, into and around the screw shaft 102. The piston 240 moves so atmospheric air 200 is drawn into the air chamber 24. When the extension tube 140 is retracted, the volume for lubricating fluid 300 inside the extension tube 145 is reduced which causes lubricating fluid 300 to flow back into the lubrication fluid chamber 246. Air inside 320 the air chamber 242 is forced outward. The piston moves to accommodate the changes of volume of the lubricating fluid 300 in the chamber 246.

In compliance with the statute, the invention described has been described in language more or less specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted under the doctrine of equivalents.

### INDUSTRIAL APPLICABILITY

This invention has application in the tools and machinery industry. More specifically, in industries that require linear drive activators and roller screws and roller bearings.

I claim:

1. A linear drive actuator 10 that includes at least one primary motor 50, comprising:
a. a roller screw assembly that includes a hollow roller screw shaft 102 coupled to the primary motor 50 and configured to selectively rotate the roller screw shaft 102 in a clockwise and counterclockwise direction, the roller screw shaft 102 includes a proximal end 104 and a distal end 106;
b. a thrust bearing 120 located near the roller screw shaft 102 near the proximal end 104, said thrust bearing 120 includes an outer race with internal non-helical grooves, an inner race formed on said roller screw shaft 102 with external non-helical grooves, and a plurality of axially aligned rollers disposed between the outer race and the inner race, said rollers include external threads configured to simultaneously engage said non-helical grooves on said outer race and said non-helical grooves on said inner race thereby move the roller screw shaft axially when the roller screw shaft 102 is rotated, the roller screw shaft 102 includes a plurality of external non-helical grooves ;
c. an elongated main housing 150 with a proximal end opening 152, a distal end opening 154 and an internal cavity 156;
d. a multiple gearbox assembly 60 that includes a gearbox housing 61 configured to receive the outer race of the thrust bearing 120, the gearbox housing 61 includes an internal cavity containing a plurality of gears coupled to said roller screw shaft 102 on the primary motor 55;
e. a thrust bearing retainer plate 120 disposed around the roller screw shaft 102, said thrust bearing retainer plate 120 configured to be placed over the proximal end opening of the main housing 150 to form a close cavity inside the main housing 150 and over the distal end opening of the gearbox housing 61;
f. a roller nut 134 configured to move axially over the roller screw shaft with the roller screw shaft 102 is rotated, the roller nut includes an outer nut housing 136;
g. a hollow extension tube 145 axially aligned and around the roller screw shaft 102, the extension tube 145 being attached to the roller nut 134 so the extension tube moves axially over the shaft 102 and inside the main housing 150 when the roller nut 134 is rotated on the screw shat 102, the extension tube being sufficient in length to extend through the main tube when the roller nut 134 is rotated on the screw shaft 102;
h. a volume compensation housing 222 with a filling cavity ______ containing a sealing piston ______ that divides the filling cavity ______ into a lubricating holding chamber 16 and an air chamber ______, the volume compensation housing 222 includes an air hole that enables atmospheric air 320 to flow back and forth between the atmosphere and the air chamber and remain substantially equal, the lubrication holding chamber 26 filled with a lubricating fluid 300, the lubricating holding chamber communicating with the motor assembly, the multiple gear assembly, the thrust bearing and the extension tube; and
i. a sufficient amount of lubricating fluid 300 dispensed into the lubricating fluid chamber to at least partially fill the lubrication holding chamber and partially fill the extension tube 145; and
j. whereby when the primary motor 50 is activated and causes the roller nut 134 to move axially over the roller screw shaft 102, the extension tube 145 either retracts or extends inside the interior cavity in the main housing 150 which changes the hydraulic pressure on the lubricating fluid 300 inside the volume compensation housing 222 and causes the piston 240 to also move so that the pressure inside the air chamber 18 equals the atmospheric pressure 320.

2. The linear drive actuator, as recited in claim 1, where said primary motor 55 is mounted on a motor bracket located between the volume compensation housing 222 and the gearbox housing 61.

3. The linear drive actuator, as recited in claim 1, wherein the primary motor 55 is connected to a pinion gear ______ and the gearbox housing 61 includes a carrier ring coaxially aligned with said pinion, said carrier ring also includes at least three inner planet gears that mesh with the pinion gear, the gearbox housing also contains an outer ring gear that meshes with the inner planetary gears.

4. The linear drive actuator, as recited in claim 1, further including a secondary motor 60 coupled to the outer ring gear that causes the outer ring gear to rotate in a direction opposite the planet gears.

5. The linear drive actuator, as recited in claim 4, further including a torque sensing system coupled to the secondary motor 55 causing activation of the secondary motor 5 when a first threshold level of load is exerted on the extension tube 145, the torque sensing system configured to activate the secondary motor 55 and apply a holding braking to the ring gear when a second threshold level of load greater than the first load level is exerted on the extension tube 145.

6. The linear drive actuator as recited in claim 5, wherein the torque sensing system comprises at least one support pin on the second and third stage ring gears ______, ______ that engage circumferentially disposed spring elements contained in the gearbox housing that allow for the continuous rotational deflection of the ring gear element in response to the output load exerted on the extension tube 145.

7. A linear drive actuator, comprising;
a. a threaded hollow roller screw shaft 102 with a thrust bearing 120 formed on one end and a roller screw nut 134 mounted on the roller screw shaft 102 configured to move axially over the roller screw shaft 102 when the roller screw shaft 102 is rotated, the roller screw shaft 102 includes a proximal end;
b. a main housing 150 with an internal closed cavity;
c. a hollow extension tube 145 attached to the roller screw nut 120 that extends into the closed cavity in the main housing 150, the extension tube 145 includes a distal end that extends through the main housing 150;
d. a motor housing 51 containing a primary motor 50;
e. a multiple gear assembly 60 coupled to the primary motor 50, the gearbox assembly 60 coupled to the roller screw shaft 102; and
f. a volume compensator housing 222 with a filling cavity containing a sealing piston 20 that divides the filling cavity into a lubricating fluid chamber and an air chamber, the volume compensation housing 222 includes an air hole that enables atmospheric air to flow back and forth between the atmosphere and the air chamber and remain substantially equal, the lubrication holding chamber filled with a lubricating fluid 300.

8. The linear drive actuator, as recited in claim 7, wherein the motor assembly 40, and the multiple gearbox assembly, and screw shaft are configured so that lubricating fluid flows freely thereby.

9. The linear drive actuator, as recited in claim 8, wherein the primary motor 50 is connected to a pinion gear and the gearbox housing includes a carrier ring coaxially aligned with said pinion, said carrier ring ______ also includes three inner planet gears that mesh with the pinion gear, the gearbox housing 82 also contains an outer ring gear that meshes with the inner planetary gears.

10. The linear drive actuator, as recited in claim 9, further including a secondary motor 55 coupled to the outer ring gear that causes the outer ring gear to rotate in a direction opposite the planet gears.

11. The linear drive actuator, as recited in claim 9, wherein the multiple gear assembly includes a torque sensing feature wherein the secondary motor 55 is activated when first threshold level of load is exerted on the extension tube 145, the torque sensing system configured to activate the secondary motor 55 and apply a holding braking to the ring gear when a second threshold level of load greater than the first load level is exerted on the extension tube 145.

12. A linear drive mechanism for a linear drive actuator, comprising:
a. a screw shaft 102 with helical threads formed thereon, the shaft with a proximal end and a distal end;
b. an outer race located around the proximal end of the threaded shaft and fixed axially inside the linear drive actuator, the outer race includes a set of non-helical grooves formed on its inside surface;
c. plurality of parallel rollers longitudinally and axially aligned inside the outer race, each roller includes a plurality of teeth configured to mesh with the grooves formed on the outer race;
d. an inner race located inside the rollers, the inner race includes a plurality of non-helical outer grooves configured to mesh with the teeth on the roller;
e. a roller nut 134 located around the distal end of the threaded shaft, the roller nut includes a cylindrical nut body with a center bore, said center bore having internal helical grooves and a circumferentially extending cross-over region wherein said helical grooves extend radially outward and extend axially, a shaft with external helical threads formed thereon, said shaft being disposed inside said center bore of said nut body, a plurality of rollers disposed inside said center bore and aligned radially around the shaft, each roller including a plurality of non-helical grooves configured to engage the helical grooves on said nut body, and at least one compression ring located inside said nut body and around said shaft configured to force the rollers outward towards said nut body.

13. The linear drive mechanism as recited in claim 13 wherein said screw shaft 102 includes an axially aligned center bore 108.

14. The linear drive mechanism as recited in claim 13, further include an extension tube 145 axially aligned with the screw shaft 102, the extension tube 145 coupled to the nut body 134 so the extension tube 145 moves axially when the nut body 134 moved axially over the screw shaft 102
